(19) United States
(12) Patent Application Publication
(10) Pub. No.: US 2013/0140837 A1
(43) Pub. Date: Jun. 6, 2013

(54) PORTABLE COMPUTER HOLDER WITH ADJUSTABLE HAND GRIP

(71) Applicant: FreeOneHand, LP, Philadelphia, PA (US)

(72) Inventor: James J. CARROLL, Richboro, PA (US)

(73) Assignee: FreeOneHand, LP, Philadelphia, PA (US)

(21) Appl. No.: 13/730,426

(22) Filed: Dec. 28, 2012

Related U.S. Application Data
(63) Continuation-in-part of application No. 12/916,092, filed on Oct. 29, 2010.

(51) Int. Cl. F16M 13/04; F16M 13/06

(52) U.S. Cl. CPC F16M 13/04; F16M 13/06
USPC 294/142

(57) ABSTRACT

An apparatus and method for ergonomically and securely holding a portable computing device and standing the portable computing device at least partially upright on a flat surface are disclosed. The apparatus and method include a holder base with a front face and a rear face opposite the front face, the holder base being configured to hold a portable computing device at its front face by engaging distal edges of the portable computing device, a dome-shaped grip extending from the rear face of the holder base, the dome-shaped grip having at least one opening for receiving a user's finger, and a flange extending from the dome-shaped grip for supporting the holder base at an angle on a flat surface. The dome-shaped grip is configured to be collapsible so that it can be easily stored when not in use.

### RELATED APPLICATIONS

The present application is a continuation-in-part of U.S. Pub. No. 2012/0104185, the entire contents of which are hereby incorporated by reference.

### BACKGROUND OF THE INVENTION

1. Field of the Invention

The present invention relates to an apparatus and method for holding a portable computing device. In particular, the present invention relates to an apparatus and method for ergonomically and securely holding a portable computing device with one hand and for standing it at least partially upright on a work surface.

2. Description of the Related Art

With the increasingly widespread availability of wireless communication network connectivity, such as via cellular phone data networks (e.g., 3G data networks, 4G data networks, etc.) and wireless internet networks (e.g., wireless fidelity (Wi-Fi) networks, wireless local area networks (WLANs), wide area networks (WANs), etc.), there has been a corresponding increase in the popularity of portable computing devices (e.g., tablet computers, KINDLE brand portable reading devices, IPAD brand portable multimedia devices, etc.). Such portable computing devices are designed to allow users to engage in various computer-related activities (e.g., browsing the internet, reading and sending e-mail, reading and drafting documents, data entry, shopping, etc.) away from a desk or other work surface (e.g., sitting on a couch, sitting on a subway train, standing up, etc.). Accordingly, they are relatively small in size so they can be more easily transported (e.g., in a purse or briefcase) while remaining large enough to provide a dynamic and meaningful user interface (e.g., a large display and a functional keyboard).

Portable computing devices are typically provided in the shape of a flat tablet or notebook. And because users will need at least one hand free to interact with the portable computing device via its user interface, the device will often need to be held only by the other hand. But the requirement that the portable computing device be large enough to provide a dynamic and meaningful user interface often makes gripping such tablet-shaped devices awkward, and even painful—particularly for prolonged periods of use. For example, merely wrapping the fingers of one hand around the peripheral edge of the device while using the other hand to interact with the user interface of the device can result in injuries to the fingers and/or wrist of the gripping hand after prolonged periods of use (e.g., Carpal Tunnel Syndrome). Moreover, when gripping such devices is awkward, users are more prone to drop and damage them. Accordingly, there is a need for an apparatus and method for ergonomically and securely holding a portable computing device with one hand.

In addition, because portable computing devices are typically provided in the shape of a flat tablet or notebook, they will lie flat on a desk or other work surface when placed thereon. That orientation is not ideal for interacting with the device because it does not provide a good angle from which the user can view the display of the user interface. Although stands for holding portable computing devices at a desirable viewing are known, such stands are generally bulky and, therefore, not suited for being carried around with the device (e.g., in a purse or briefcase). Moreover, those stands are not suitable for ergonomically and securely holding the device with one hand. Accordingly, there is a need for an apparatus and method that is not only suited for ergonomically and securely holding a portable computing device with one hand, but that is also suitable for standing it at least partially upright on a work surface.

### SUMMARY OF THE INVENTION

To resolve at least the problems discussed above, it is an object of the present invention to provide an apparatus and method for ergonomically and securely holding a portable computing device and standing the portable computing device at least partially upright on a flat surface. The apparatus and method include a holder base with a front face and a rear face opposite the front face, the holder base being configured to hold a portable computing device at its front face by engaging distal edges of the portable computing device, a dome-shaped grip extending from the rear face of the holder base, the dome-shaped grip having at least one opening for receiving a user's finger, and a flange extending from the dome-shaped grip for supporting the holder base at an angle on a flat surface. And the holder base may include a central portion configured to mount flush with a rear face of the portable computing device, a plurality of arms extending from the central portion at different angles, the plurality of arms also being configured to mount flush with the rear face of the portable computing device, and a curved lip at a distal end of each of the plurality of arms, each curved having a grooved portion configured to hold a distal edge of the portable computing device therein.

It is a further object to provide a domed grip that is collapsible. The grip can be placed in a collapsed position for ease of storage. When it is ready to be used, the user can place the grip in an expanded position. Those and other objects, advantages, and features of the present invention will become more readily apparent by the following written description, taken in conjunction with the accompanying drawings and claims.

### BRIEF DESCRIPTION OF THE DRAWINGS

Many aspects of the present invention can be better understood with reference to the accompanying drawings, which are part of the specification and represent exemplary embodiments of the present invention. The components in the drawings are not necessarily to scale, emphasis instead being placed upon illustrating the principles of the present invention. And in the drawings, like reference numerals designate corresponding parts throughout the several views.

FIG. 1A is an isometric view illustrating a portable computer holder according to a non-limiting embodiment of the present invention;

FIG. 1B is a sectional view of the portable computer holder illustrated in FIG. 1A taken along line B-B;

FIG. 2A is an isometric view illustrating the holder base of the portable computer holder illustrated in FIG. 1A;

FIG. 2B is a plan view of the holder base illustrated in FIG. 2A;

FIG. 2C is an elevation view of the holder base illustrated in FIG. 2A;

FIG. 3A is an isometric view illustrating the grip flange of the portable computer holder illustrated in FIG. 1A;

FIG. 3B is an elevation view of the grip flange illustrated in FIG. 3A;

FIG. 4A is an isometric view illustrating an example of one of the ergonomic and secure grip positions a user can enjoy with the portable computer holder of FIG. 1A;

FIG. 4B is an isometric view illustrating an example of another one of the ergonomic and secure grip positions a user can enjoy with the portable computer holder of FIG. 1A;

FIG. 5A is an elevation view taken from the side illustrating the portable computer holder of FIG. 1A standing partially upright on a flat surface;

FIG. 5B is an elevation view taken from the rear illustrating the portable computer holder of FIG. 1A standing partially upright on a flat surface;

FIG. 6A is an isometric view illustrating the cover of the portable computer holder illustrated in FIG. 1A;

FIG. 6B is an elevation view of the cover illustrated in FIG. 6A;

FIG. 7A is an isometric view illustrating a belt clip according to a non-limiting embodiment of the present invention;

FIG. 7B is an elevation view of the belt clip illustrated in FIG. 7A;

FIG. 7C is an isometric view illustrating the belt clip of FIG. 7A installed on the portable computer holder illustrated in FIG. 1A;

FIG. 8 is a plan view of a portable computer holder according to another non-limiting embodiment of the present invention;

FIG. 9 is a perspective view of another embodiment of a portable computer holder with a hand grip mechanism in a storage position;

FIG. 10 is a side view of the holder of FIG. 9;

FIG. 11 is a perspective view of the holder of FIG. 9 with the hand grip mechanism in the operating position;

FIG. 12 is a cross-sectional view of the hand grip mechanism in the operating position;

FIG. 13 is a cross-sectional side view of the hand grip mechanism in the operating position;

FIG. 14 is a perspective view of another embodiment of a portable computer holder with the hand grip mechanism in the operating position;

FIG. 15 is a perspective view of the holder of FIG. 14 with the hand grip mechanism in the storage position;

FIG. 16 is a side view of the holder of FIG. 15; and,

FIG. 17 is a cross-sectional view of the holder of FIGS. 14-16, showing both the operating and storage positions.

### DETAILED DESCRIPTION OF THE PREFERRED EMBODIMENTS

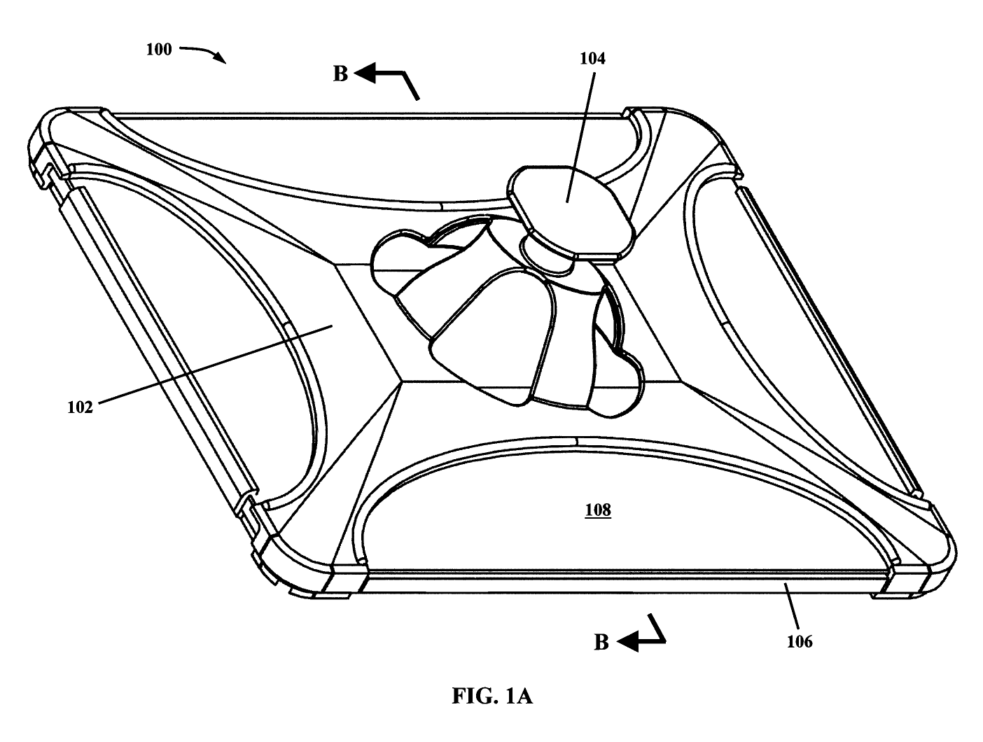

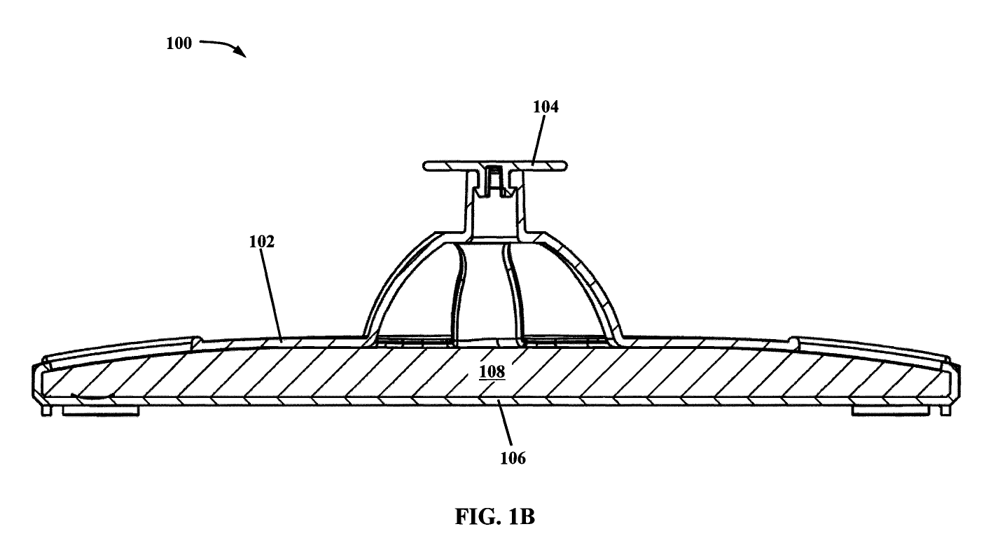

Turning to FIGS. 1A and 1B, the portable computer holder 100 of the present invention includes a holder base 102, a grip flange 104, and a front cover 106. A portable computing device 108 is disposed in the holder base 102 so it can be ergonomically and securely gripped, and a front cover 106 is removable attached to the portable computing device 108 to protect the user interface portion at the front face of the portable computing device 108 from contaminants and scratching when not in use. The front cover 106 is removed from the portable computing device 108 when a user is interacting with the portable computing device 108. The grip flange 104 operates as a counterweight and provides additional grip for a user when holding the holder base 102 and portable computing device 108 in one hand. The flange grip 102 also provides a mechanism for standing the holder base 102 and portable computing device 108 at least partially upright on a work surface. Accordingly, the present invention is suited both for ergonomically and securely holding a portable computing device with one hand and for standing it at least partially upright on a work surface.

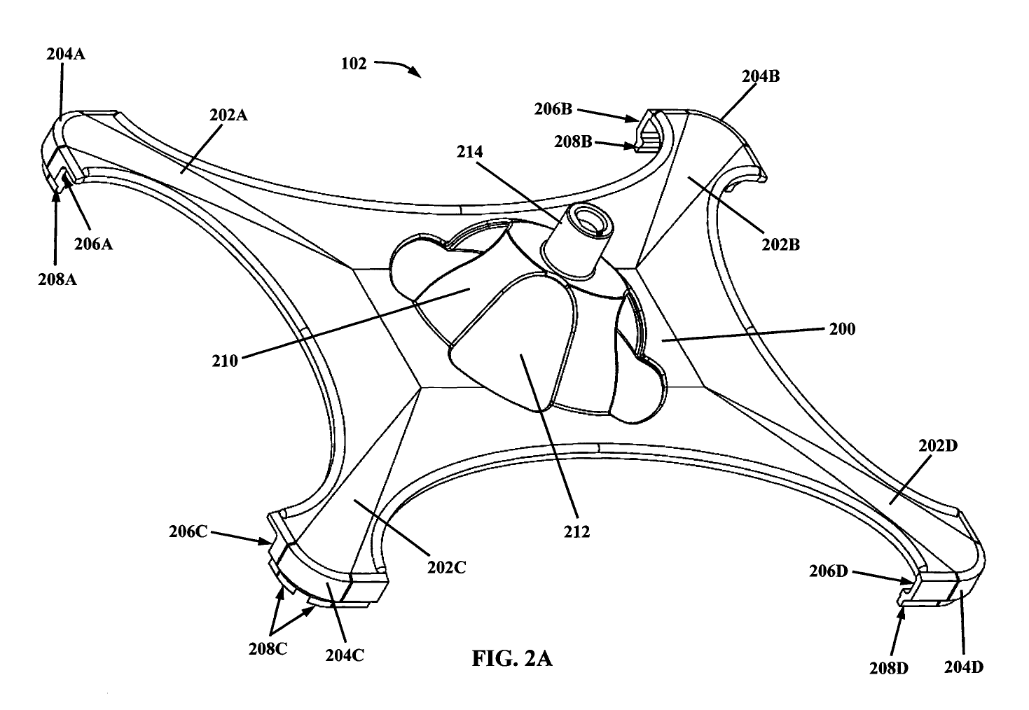

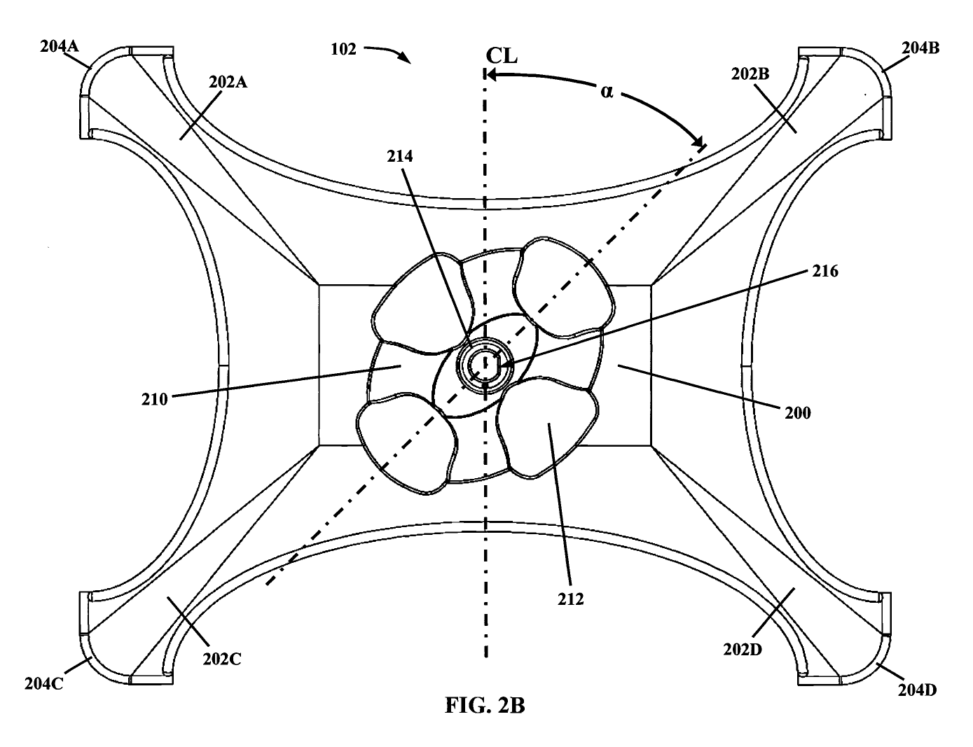

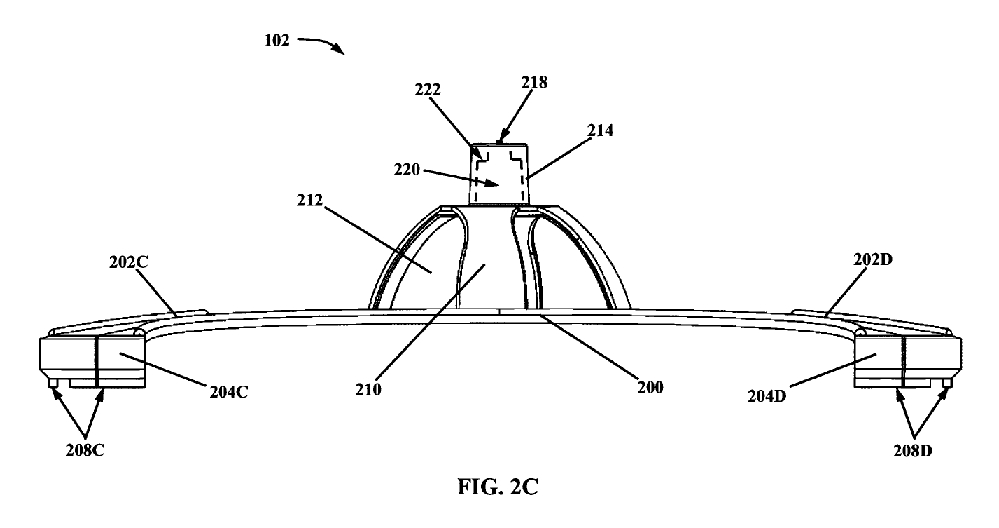

As illustrated in more detail in FIGS. 2A-2C, the holder base 102 includes a central portion 200 from which four arms 202A-202D extend. The central portion 200 provides a substantially flat surface that is configured to mount flush with the rear face of the portable computing device 108. Accordingly, the central portion 200 is substantially parallel to a plane defined by the rear face of the portable computing device 108. The four arms 202A-202D extend from the central portion 200 in substantially the same plane as the central portion 200 in directions corresponding to the four corners of the portable computing device 108.

At the distal end of each of the form arms 202A-202D is a corresponding curved lip 204A-204D configured to wrap around a respective corner of the portable computing device 108. The curved lips 204A-204D are positioned at the four corners of the portable computing device 108 to hold the portable computing device 108 securely in lateral directions (i.e., in directions parallel to the plane defined by the rear face of the portable computing device 108). Each curved lip 204A-204D includes a grooved portion 206A-206D that is formed substantially perpendicular to the central portion 200 of the holder base 102 and, therefore, substantially perpendicular to the plane defined by the rear face of the portable computing device 108. Each grooved portion 206A-206D is approximately the same width as the thickness of the portable computing device 108 so that the respective corners of the portable computing device 108 can be disposed therein. Part of each grooved portion 206A-206D extends over the front face of the portable computing device 108 to hold the portable computing device 108 securely in the vertical direction (i.e., in the direction perpendicular to the plane defined by the rear face of the portable computing device 108).

Preferably, each grooved portion 206A-206D has a width slightly less than the thickness of the portable computing device 108 so as to provide an interference fit between the curved lips 204A-204D and the corners of the portable computing device 108. The holder base 102 is preferably made from a flexible material, such as a thermoplastic elastomer (e.g., santoprene, Alcryn, Estane, Hytrel, Low-density polyethylene (LDPE), etc.), so that one or more of the four arms 202A-202D and/or curved lips 204A-204D can be manipulated (e.g., bent, folded, rotated, etc.) to allow installation of the portable computing device 108 in the holder base 102 between the curved lips 204A-204D and within the grooved portions 206A-206D of the curved lips 204A-204D. The holder base 102 is also preferably made from a flexible material so the central portion 200 and arms 202A-202D can conform to the shape of the rear face of the portable computing device 108 when the rear face of the portable computing device 108 is not perfectly flat. And the holder base 102 is preferably dimensioned to suit the specific size and shape of a particular portable computing device 108 so as to ensure that particular portable computing device 108 is held as securely as possible at its corners by the four curved lips 204A-204D of the holder base 102.

One or more feet 208A-208D are provided on the part of each grooved portion 206A-206D that extends over the front face of the portable computing device 108. Each of the feet 208A-208D extends substantially perpendicular to the front face of the portable computing device 108 at a peripheral edge of a corresponding curved lip 204A-204D. The feet 208A-208D are configured to extend beyond the front face of the portable computing device 108 to protect the front face when the holder base 102 and portable computing device 108 are placed on a flat surface with the front face of the portable computing device 108 facing toward the flat surface (i.e., a face-down position). And the part of each grooved portion 206A-206D that extends over the front face of the portable computing device 108 only extends over the front face of the portable computing device 108 a sufficient amount to secure it in place while leaving the user interface—in particular, the display—of the portable computing device fully accessible to the user. In that way, the curved lips 204A-204D at the corners of the holder base 102 secure the portable computing device 108 and protect its front face while leaving the user interface portion fully accessible to the user.

Extending from the central portion 200 of the holder base 102 is a domed structure 210 with which a user can ergonomically and securely grip the holder base 102 and, therefore, the portable computing device 108 when it is installed therein. As illustrated in FIG. 2B, the domed structure 210 is elliptical in cross section with its major axis and minor axis lying in the same plane as the central portion 200 of the holder base 102. As illustrated in FIG. 2C, the domed structure 210 is in the shape of half an ellipse (e.g., a parabola) in a direction perpendicular to its cross section. And as also illustrated in FIG. 2B, the domed structure 210 is angled with respect to the rectangular shape of the holder base 102 defined by its four corners at feet 208A-208D. Preferably, the major axis of the elliptical shape of the domed structure 210 is at an angle α of about +45° with respect to the centerline (dotted-dashed line), or axis of symmetry, of the holder base 102.

The domed structure 210 is elliptical so that it will easily fit in various hand sizes. For example, users with smaller hands can grip the domed structure 210 around its minor axis so the users' fingers do not need to travel as far from one side of the domed structure to the other and the domed structure will comfortably fill the user's hand. And users with larger hands can grip the domed structure 210 around its major axis so the users' fingers will need to travel far enough from one side of the domed structure 210 to the other that the domed structure 210 comfortably fills the user's hand. By fitting different hands sizes in that way, the elliptical shape of the domed structure 210 helps ensure the user's grip is not only comfortable, but also secure.

The domed structure 210 is positioned at an angle α so it will more naturally fit in a user's hand when the user is holding the portable computer holder 100 and portable computing device 108 at a position in front of his or her body. Accordingly, that angle α corresponds to the angle of a user's arm when the user holds the holder base 102 and portable computing device 108 centrally in front of his or her body. That angle α naturally occurs as the user's arm extends from a position at the user's side to the position centrally in front of his or her body. And that angle α can be reversed (e.g., switched from +45° to −45°) based on which hand the user will utilize to grasp the holder base 102 and portable computing device 108 as well as whether the user prefers to grip the domed structure 210 along its minor axis or its major axis. Or the domed structure 210 can be provided with a circular cross section so that it will fit a user's hand the same way regardless of the direction from which the user grasps it. And when the domed structure 210 is circular in cross section, it can be formed with different diameters to suit different hand sizes.

The domed structure 210 includes a plurality of elongated openings 212 extending from the central portion 200 of the holder base 102 toward the pinnacle of the domed structure 210. A portion of each opening may also extend into the central portion 200 of the holder base 102 in the plane of the holder portion 200. Each opening 212 is configured to receive one or more of a user's fingers therein to further provide an ergonomic and secure gripping surface. Each opening 212 is preferably rounded toward the pinnacle of the domed structure 210 to fit the contour of a finger.

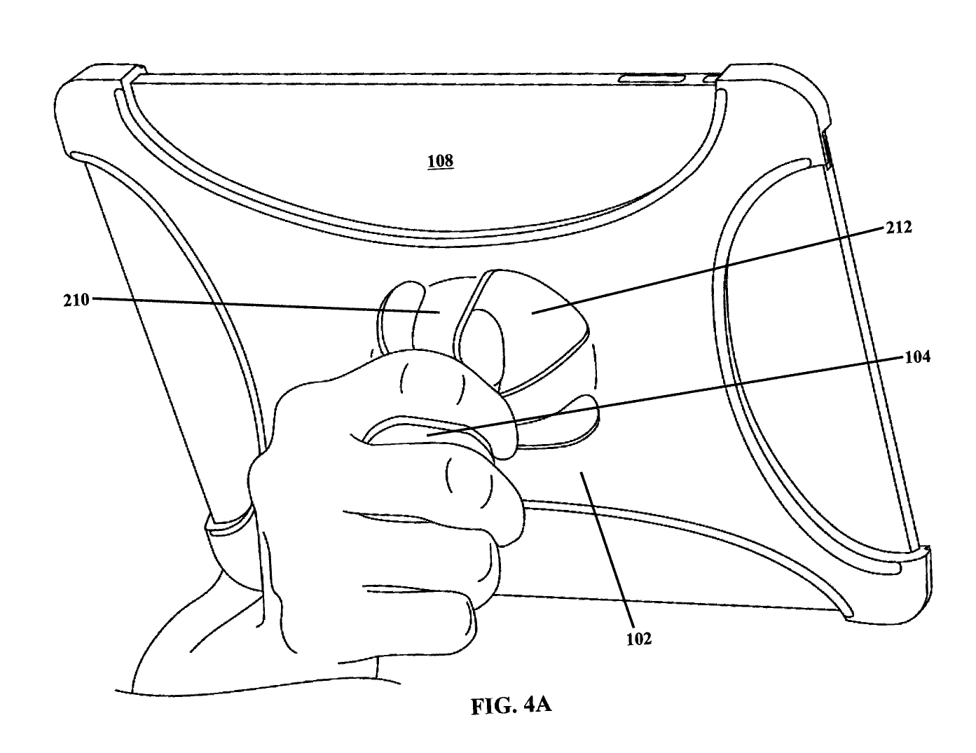

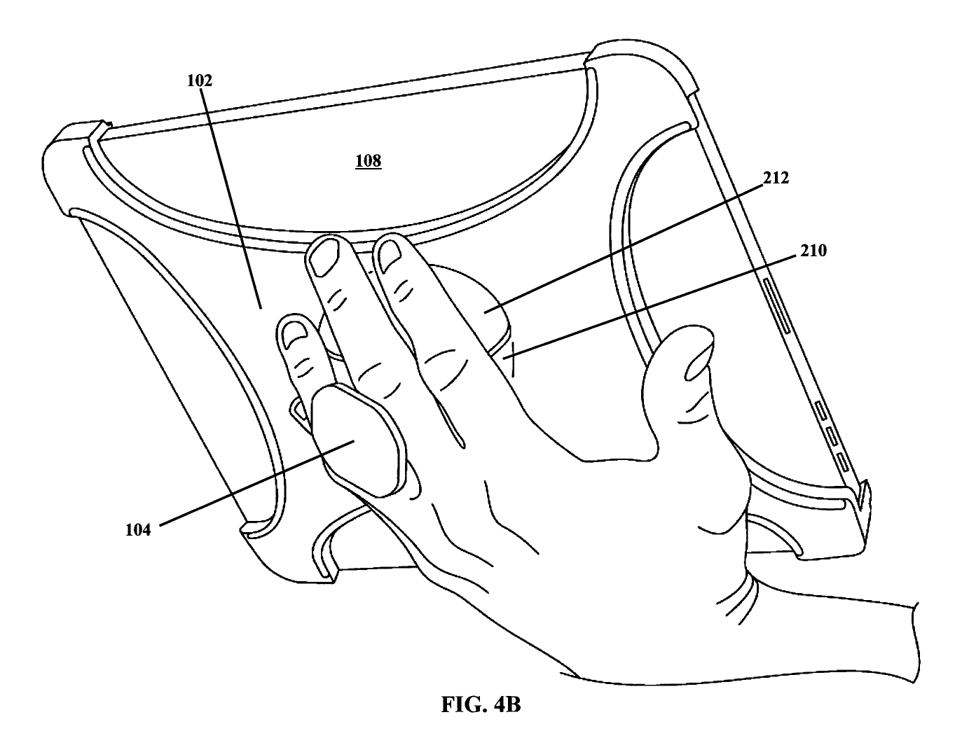

At least one of the openings 212 is placed in line with the angle α of the domed structure 210 so a user can insert one of his or her fingers—preferably the thumb—directly into that opening 212 without the need to rotate his or her hand at the wrist (see, e.g., FIG. 4A). With that opening 212 serving as a starting point, the other openings may be disposed equidistantly from each other around the perimeter of the domed structure 210 in an elliptical array. Preferably, there are four openings 212 spaced 90° apart from each other so that two of the openings 212 are opposite to each other and in line with the angle α of the domed structure 210 and the other two openings are opposite each other and perpendicular to the angle α of the domed structure 210. That configuration allows a user to insert one of his or her fingers directly into an opening 212 in four different orientations without the need to rotate his or her hand at the wrist—right-side-up and up-side-down with the longer edge of the rectangular shape of the holder base 102 parallel to the ground (i.e., right-side-up and up-side-down in the “landscape” orientation) and right-side-up and up-side-down with the longer edge of the rectangular shape of the holder base 102 perpendicular to the ground (i.e., right-side-up and up-side-down in the “portrait” orientation). Moreover, there will be an opening 212 into which a user can directly insert one of his or her fingers without bending his or her wrist in each of those orientations regardless of which hand the user utilizes to grasp the domed structure 210.

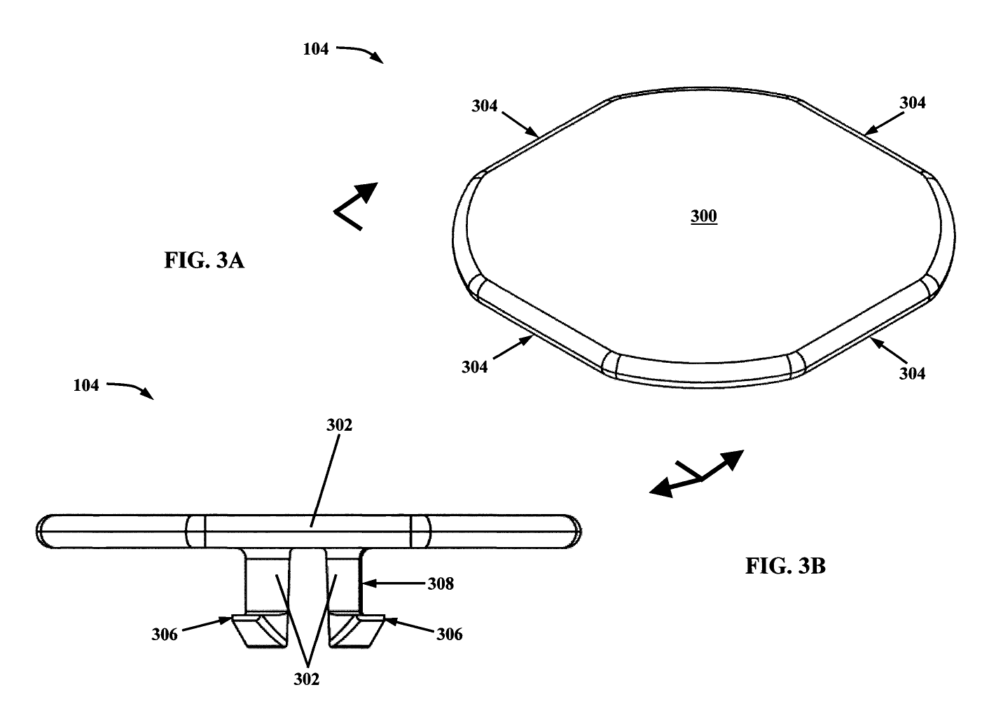

Extending from the pinnacle of the domed structure 210 is an attachment mechanism 214 for attaching the grip flange 104 to the holder base 102. The attachment mechanism 214 extends substantially perpendicular to the central portion 200 of the holder base 102 and includes a flat portion 216 (FIG. 2B) and a cylindrical tab 218 (FIG. 2C) configured to engage a corresponding flat portion 308 (FIG. 3B) and a corresponding cylindrical opening (not shown), respectively, in the grip flange 104. The attachment mechanism 214 includes a hollow bore 220 (FIG. 2C) configured to receive a plurality of attachment mechanisms 302 (FIG. 3B) on the grip flange 104. A cylindrical lip 222 (FIG. 2C) is provided on an inner wall of the bore 220 with a smaller diameter than the diameter of the bore 220 to engage hooked tabs 306 (FIG. 3B) on the attachment mechanisms 302 (FIG. 3B) of the grip flange 104, as illustrated in FIG. 1B. The flat portion 216 and the cylindrical tab 218 operate to prevent the grip flange 104 from rotating on the attachment mechanism 214 when it is attached to the holder base 102, and the cylindrical lip 222 holds the grip flange 104 securely attached to the attachment mechanism 214.

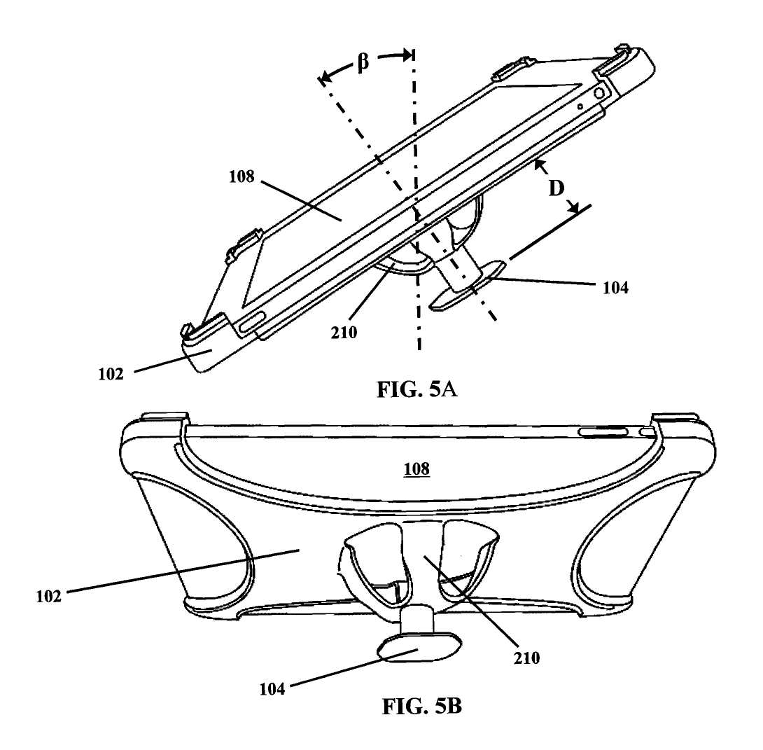

As illustrated in FIG. 3A, the grip flange 104 includes a substantially flat flange base 300. The flange base 300 includes a plurality of flat surfaces 304 at its peripheral edges that are configured to be substantially parallel with the edges of the rectangular shape of the holder base 102 defined by its four corners at feet 208A-208D. Because those flat surfaces 304 are substantially parallel with the edges of the rectangular shape of the holder base 102, they will also be parallel with the edges of a portable computing device 108 being held in the portable computer holder 100. Those flat surfaces 304 will therefore provide additional stability when standing the portable computer holder 100 and portable computing device 108 at least partially upright on a work surface (see, e.g., FIGS. 5A and 5B). Moreover, those flat surfaces will support the portable computer holder 100 and portable computing device 108 in an orientation suitable for interacting with the user interface of the portable computing device 108 (i.e., with the display of the user interface in the landscape or portrait orientation and at a good angle from which the user can view the display). In a like manner, if the portable computing device 108 is some shape other than rectangular, the flat surfaces 304 can be placed in different locations on the grip flange 104 to ensure that the user interface of the portable computing device 108 is in a suitable orientation when standing it at least partially upright on a work surface.

As illustrated in FIG. 3B, the grip flange 104 also includes a plurality of attachment mechanisms 302 extending substantially perpendicular from the flange base 300 at a central location of the flange base 300. The plurality of attachment mechanisms 302 are configured to mate with the attachment mechanism 214 on the domed structure 200 of the holder base 102. Each of those attachment mechanisms 304 includes a hooked tab 306 configured to engage the cylindrical lip 222 (FIG. 2C) in the bore 220 of the attachment mechanism 214 on the domed structure 210. And one of those attachment mechanisms 300 includes a flat portion 308 configured to engage the flat portion 216 (FIG. 2B) of the attachment mechanism 214 on the domed structure 200.

The grip flange 104 also includes a cylindrical opening (not shown) on the same side of the flange base 300 as the attachment mechanisms 302. The cylindrical opening is configured to receive the cylindrical tab 218 (FIG. 2C) of the attachment mechanism 214 on the domed structure 200 when the grip flange 104 is attached to the holder base 102. As discussed above, the cylindrical opening and flat portion 308 on the grip flange 104 operate to prevent the grip flange 104 from rotating on the attachment mechanism 214 when it is attached to the holder base 102, and the hooked tab 306 holds the grip flange 104 securely attached to the attachment mechanism 214. Other mechanisms are also envisioned for attaching the grip flange 104 to the holder base 102 without departing from the spirit and scope of the invention, such as threaded engagement, sonic welding, gluing, and forms of snapped engagement other than that described above. In the alternative, the grip flange 104 can be formed integrally with the holder base 102 from a single piece of material. Regardless of whether the holder base 102 and grip flange 104 are formed as separate pieces or formed integrally from a single piece of materially, they are preferably formed from the same material formed by injection molding.

The unique configuration of the domed structure 210 and grip flange 104 of the portable computer holder 100 provide multiple grip positions that can be used to ergonomically and securely hold a portable computing device 108 with only one hand, thereby freeing up the other hand to interact with the user interface of the portable computing device 108. As illustrated in FIG. 4A, for example, a user can place his or her thumb through the opening 212 that is in line with the angle α of the domed structure 210 while wrapping his or her other fingers and palm around the outside of the domed structure 210 and grip flange 104 so that the flange base 300 of the grip flange 104 is disposed between two of the user's adjacent fingers—preferably between the user's index finger (digitus secundus manus) and middle finger (digitus tertius). Or as illustrated in FIG. 4B, a user can wrap his or her palm and fingers around the domed structure 210 with his or her thumb facing outward away from the domed structure and the attaching mechanisms 214 and 302 of the grip flange 104 and the domed structure 210 disposed between two of the user's adjacent fingers—preferably between the user's middle finger (digitus tertius) and ring finger (digitus annularis).

In the grip position illustrated in FIG. 4A, the user's palm is substantially perpendicular to the central portion 200 of the holder base 102 and, therefore, substantially perpendicular to the plane defined by the rear face of the portable computing device 108. And because the flange base 300 of the base portion 104 is disposed between the user's fingers in that grip position, the flange base of the base portion 104 will provide additional leverage for controlling the pitch (i.e., the viewing angle) of the portable computing device 108 with the portable computer holder 100. Also in that grip position, the user's wrist is neutral to 5° and the weight of the portable computer holder 100 and portable computing device 108 are supported by the larger, stronger muscles in the user's hand and wrist. Accordingly, that grip position is five times more efficient (i.e., it consumes less of the user's energy) than holding the portable computing device 108 by wrapping the fingers of one hand around the peripheral edge of the portable computing device 108.

In the grip position illustrated in FIG. 4B, the user's fingers are spread across the central portion 200 of the holder base 102 and the rear face of the portable computing device 108. By spreading the user's fingers across the central portion 200 of the holder base 102 and the rear face of the portable computing device 108, a broader and more stable base is provided for holding the portable computer holder 100 and portable computing device 108. And because the user's hand is disposed between the central portion 200 of the holder base 102 and the flange base 300 of the grip flange 104 in that grip position, the portable computer holder 100 is held securely to the user's hand by the grip flange 104. Also in that position, the portable computer holder 100 and portable computing device 108 are supported by the larger, stronger muscles in the user's arm and elbow. And like the grip position illustrated in FIG. 4A, the grip position illustrated in FIG. 4B is significantly more efficient than holding the portable computing device 108 by wrapping the fingers of one hand around the peripheral edge of the portable computing device 108. Various other grip positions are also possible that provide similar advantages.

In addition to providing extra leverage and a more secure grip, the grip flange 104 operates as a counterweight to help balance the portable computer holder 100 and portable computing device 108 in a user's hand. The grip flange 104 also allows the portable computer holder 100 and portable computing device 108 to be stood at least partially upright on a flat surface, similar to the easel on a picture frame. Accordingly, as illustrated in FIGS. 5A and 5B, the grip flange 104 is configured to extend from the domed structure 210 of the holder base 102 a sufficient distance D to support the portable computer holder 100 at a desirable angle β for viewing and interacting with the user interface of the portable computing device 108. And as discussed above, the flat surfaces 304 at the peripheral edges of the flange base 300 provide additional stability for supporting the portable computer holder 100 and portable computing device 108 with the display of the user interface in the landscape or portrait orientation and at a good angle from which the user can view the display.

By requiring the user to use less energy to grip the portable computing device 108, the portable computer holder 100 of the present invention allows a user to grip the portable computing device 108 more comfortably for longer periods of time. Accordingly, the portable computer holder 100 of the present invention reduces the likelihood of injuries to a user's fingers and/or wrist due to prolonged use of a portable computing device 108. The likelihood of injury is further reduced by the portable computer holder 100 of the present invention because the different grip positions allow a user to utilize different muscles to support and stabilize the portable computer holder 100 and portable computing device 108. Thus, a user can switch between many different grip positions if one of those grip positions becomes tiresome and/or uncomfortable. Moreover, by providing a stable and secure grip for holding the portable computing device 108, the portable computer holder 100 of the present invention also greatly reduces the likelihood of dropping and damaging often-expensive portable computer devices 108.

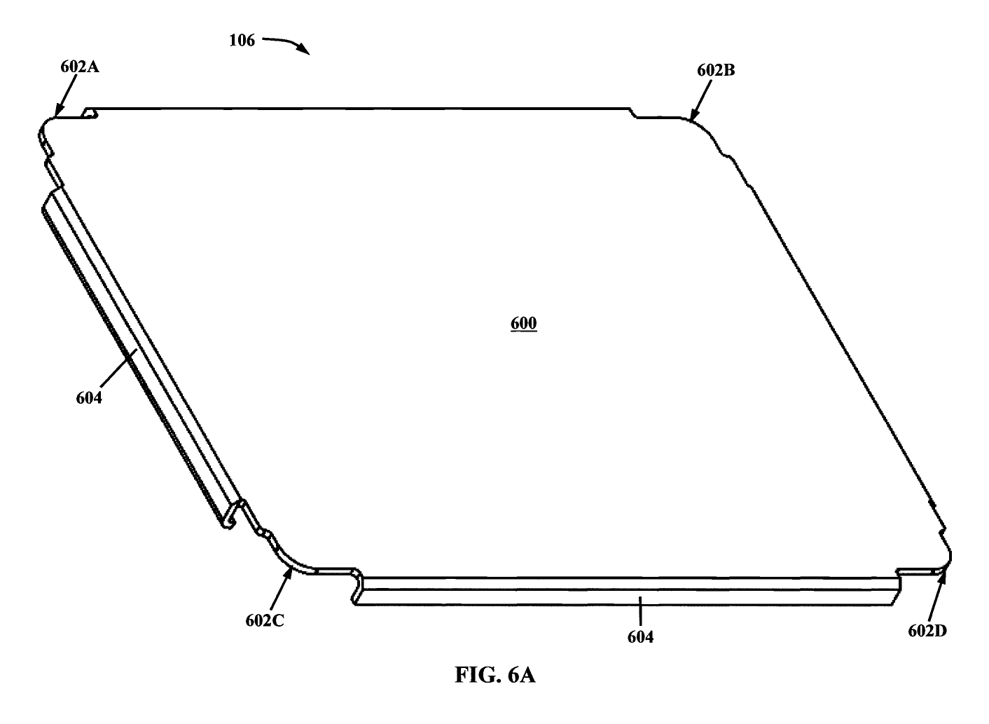

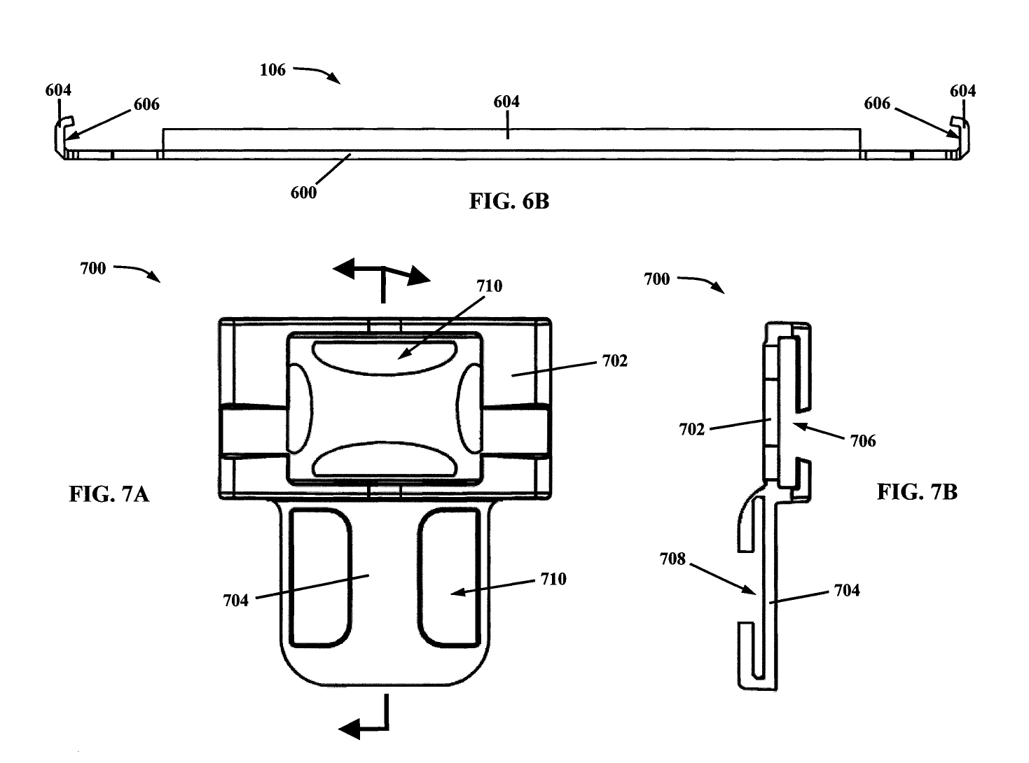

As illustrated in FIGS. 6A and 6B, the cover 106 for the portable computer holder 100 includes a substantially flat main body 600 that is configured to mount flush with and cover the front face of the portable computing device 108. Accordingly, the main body is substantially parallel to a plane defined by the front face of the portable computing device 108 and is substantially the same shape as the front face of the portable computing device 108, except where the curved lips 204A-204D at the corners of the holder base 102 extend over the front face of the portable computing device 108. The main body includes cutout portions 602A-602D at each of its four corners that are configured to receive the curved lips 204A-204D at the corners of the holder base 102 when both the holder base 102 and the cover 106 are installed on the portable computing device 108. Accordingly, the entire front face of the portable computing device 108 will be covered when the portable computing device 108 is installed between the holder base 102 and the cover 106.

The main body 600 of the cover 106 also includes a plurality of curved lips 604 extending substantially perpendicular to the plane in which the main body 600 lies and, therefore, substantially perpendicular to the plane defined by the front face of the portable computing device 108. Each curved lip 604 includes a grooved portion 606 that is formed substantially perpendicular to the main body 600. Like the grooved portions 206A-206D in the curved lips 204A-204D of the holder base 102, each grooved portion 606 in the curved lips 604 of the cover 106 is approximately the same width as the thickness of the portable computing device 108 so that the sides of the portable computing device 108 can be disposed therein. Part of each grooved portion 606 extends over the rear face of the portable computing device 108 so it is held securely to the portable computing device 108 in the vertical direction (i.e., in the direction perpendicular to the plane defined by the front face of the portable computing device 108).

Also like the grooved portions 206A-206D in the curved lips 204A-204D of the holder base 102, each grooved portion 606 in the curved lips 604 of the cover 106 preferably has a width slightly less than the thickness of the portable computing device 108 so as to provide an interference fit between the curved lips 604 and the sides of the portable computing device 108. Accordingly, the cover 106 is preferably made from a somewhat flexible material so the curved lips 604 can be manipulated (e.g., bent, folded, deflected, etc.) around the portable computing device 108 to allow installation of the cover 106 on the portable computing device 108. That material, however, is preferably more rigid than the holder base 102 and grip flange 104, such as an ABS thermoplastic material, as to provide better protective qualities. And when that material is solid and opaque in the region of user interface, the cover 106 will need to be removed for a user to interact with the user interface of the portable computing device 108. In the alternative, the cover 108 can be modified to include a transparent material in the region of user interface that is more flexible than the remaining portions of the cover and/or that is electrically conductive so the user can interact with the user interface of the portable computing device 108 with the cover 106 installed thereon.

In addition to the components described above, the portable computer holder 100 of the present invention may include various other components to facilitate holding a portable computing device 108 in different manners. For example, the grip flange 104 may be removably attached to the holder base 102 so it can be replaced with various other attachment mechanisms, such as a ¼″-20 thread receptacle for mounting to a standard tripod. Or the attachment mechanism 214 on the holder base 102 can be configured so that it can be directly mounted to another device when the grip flange 104 is removed, such as by forming that attachment mechanism with a ¼″-20 thread receptacle for mounting to a standard tripod. Or other attachment mechanisms can be formed on or attached to the grip flange 104 so the grip flange 104 does not need to be removed, thereby reducing the number of parts of which a user needs to keep track.

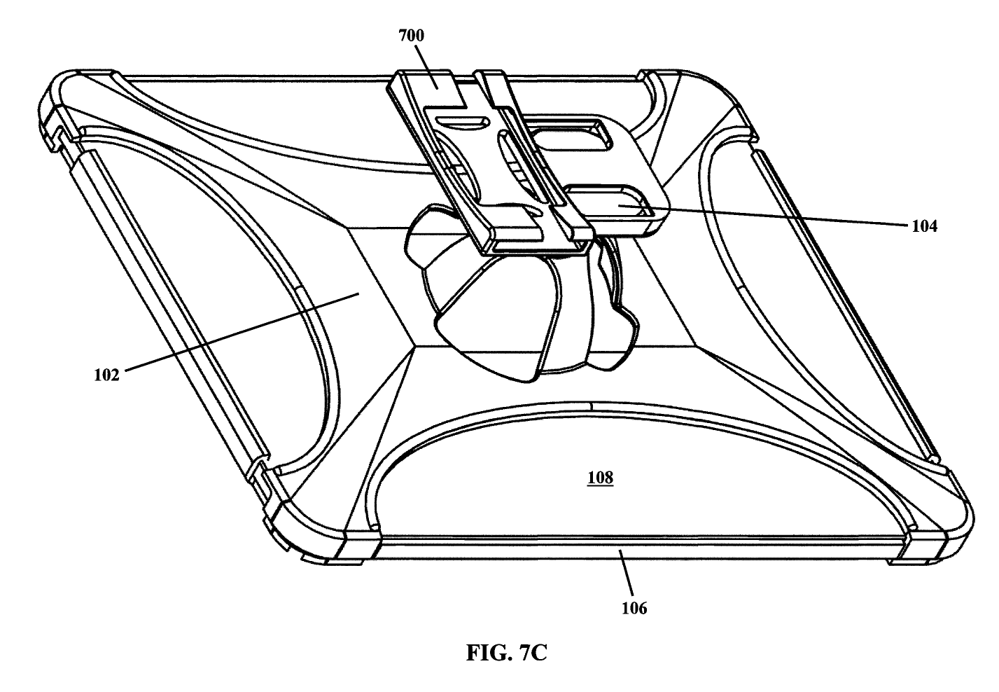

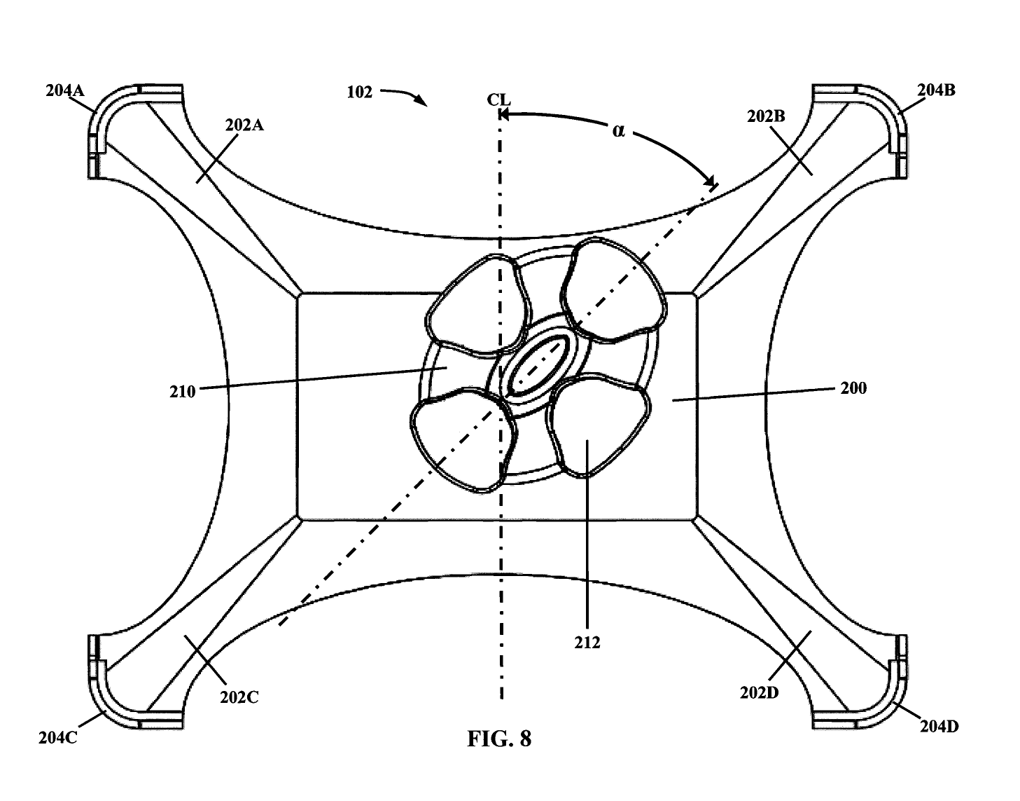

As FIGS. 7A-7C illustrate, a belt clip 700 can be attached directly to the grip flange 104 so a user can attach the portable computer holder to his or her belt. The belt clip 700 includes a rectangular upper portion 702 configured to attach to the user's belt and a rectangular lower portion 704 configured to attach to the grip flange 104. The upper portion 702 includes a groove 706 formed in a rear side thereof that is dimensioned to receive the user's belt therein. And the lower portion 704 includes a groove 708 formed in a front side thereof that is dimensioned to receive the grip base 300 of grip flange 104 therein. The groove 706 of the upper portion 702 is disposed on the opposite side of the belt clip 700 from the groove 708 of the lower portion 704 such that the portable computer holder 100 and, therefore, the front face of the portable computing device 108, will face away from the user when attached to the user's belt.

The upper portion 702 and lower portion 704 of the belt clip 700 include a plurality of openings 710 extending therethrough to reduce the weight and enhance the aesthetics of the belt clip. The lower portion 704 of the belt clip 700 further includes locking features (not shown) for keeping the grip flange 104 attached to the belt clip. Any suitable locking features can be used to provide that functionality. Other mechanisms for attaching the portable computer holder 100 to a user, such as a lanyard, may also be attached to the grip flange 104 or other part of the portable computer holder 100 in a similar manner.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. For example, the domed structure 210 may be offset from the centerline CL of the holder base 102, as illustrated in FIG. 8, so that more of a user's forearm can be used to support the weight of the portable computer holder 100 and portable computing device 108. Accordingly, it is intended that the invention be limited only to the extent required by the appended claims and the applicable rules of law.

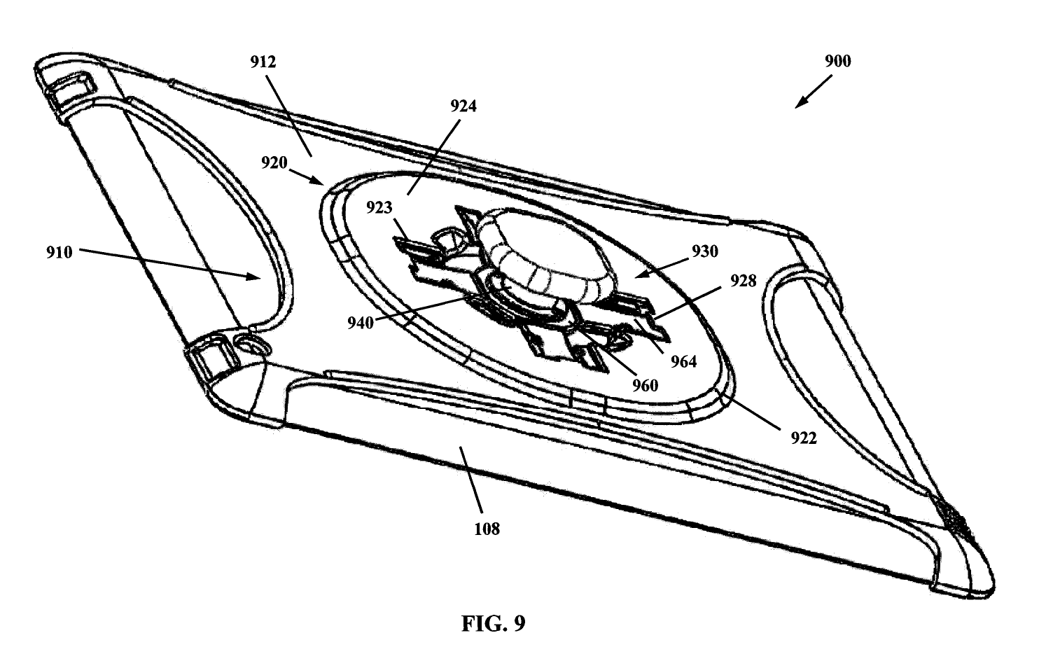

A further illustrative and non-limiting embodiment of the invention is shown in FIGS. 9-13. Here, the holder 900 includes a base 910, a raised section 920, and a handle or grip 930. The base 910 is configured the same as the base 102 shown and described with respect to FIGS. 1-8, and retains a portable computing device 108 or similar item. The base 910 has a top surface 912 with a central opening 914.

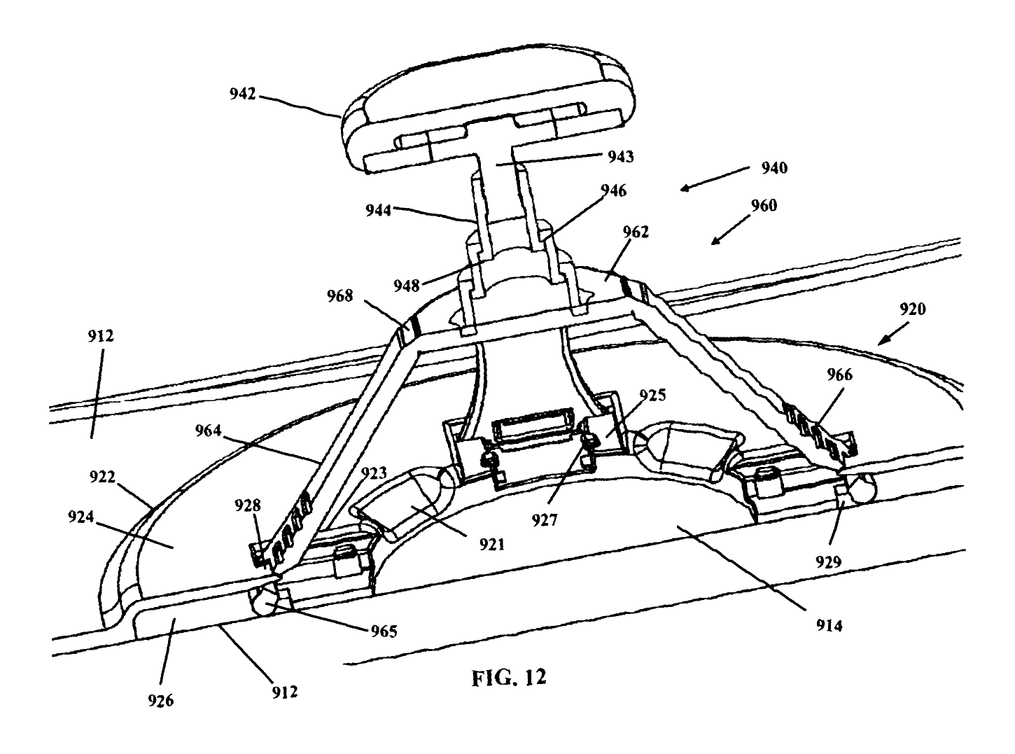

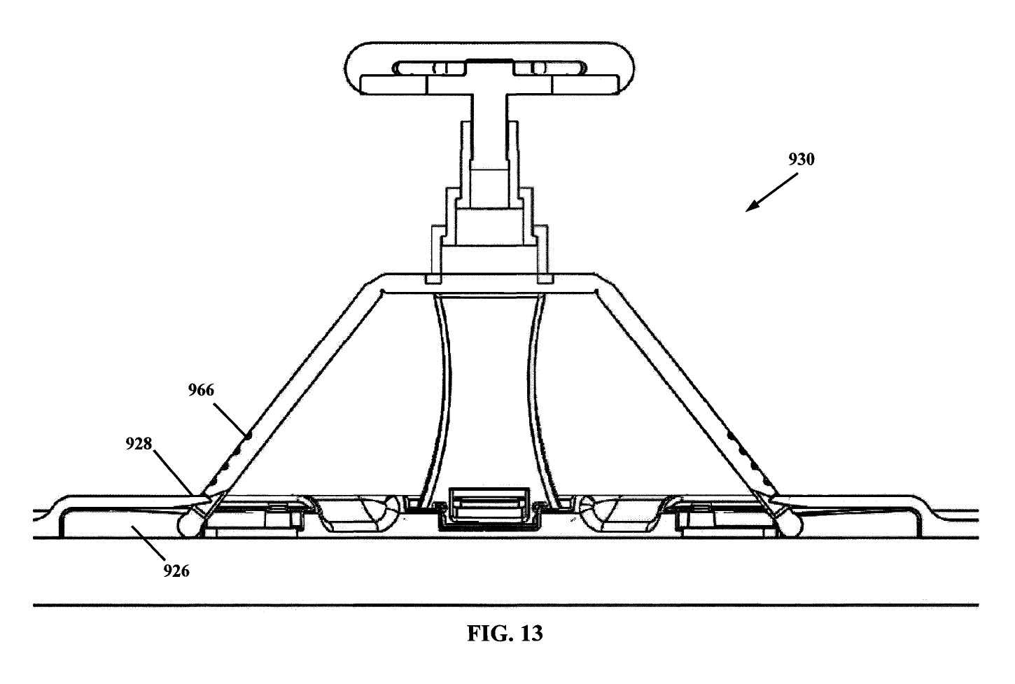

The raised section 920 is formed substantially at the center of the base 910, though can also be offset. The raised section 920 is substantially circular or oblong, and has a sloped side 922 that leads upward/outward with respect to the top surface 912 of the base 910, to a top platform 924. The raised section 920 is a thin flat member. As best shown in FIGS. 12-13, the platform 924 is substantially parallel to and spaced apart (by the side 922) from the top surface 912 of the base 910 to form a channel 926 therebetween. As with the base 910, the raised section 920 is formed of hardened material to be rigid, such as plastic. The raised section 920 can be molded integrally with the base 910, or can be a separate element that is attached (such as by adhesive or fasteners) to the base 910 so that the raised section 920. The grip 930 slidably engages the raised section 920. The raised section 920 remains fixed with respect to the base 910 and couples the grip 930 to the base 910.

Referring now to FIGS. 11-13, the hand grip or grip mechanism 930 has a handle portion 940 and a support portion 960. The handle portion 940 includes a head 942, and a telescoping body formed of a number of telescoping elements 944. The telescoping elements 944 are concentrically arranged one inside the other with increasing diameters, and substantially orthogonal to the head 942. Each element 944 is circular in shape and has a top section with an inwardly turned lip 946 and a bottom section with an outwardly turned lip 948. Accordingly, the bottom telescoping element 944 has a bottom with an outwardly turned lip 948 that engages under a lip formed in an opening in the top plate 962 of the support portion 960. The inward lip 946 of the bottom telescoping element 944 engages the outward lip 948 of the next higher (and smaller) telescoping element 944. That relationship continues, with the top telescoping element 944 engaging a T-shaped adapter 943 of the head 942, such as by mating lips or the like. The T-shaped adapter 943 has a neck formed by a downward extending rod that enters the hollow core of the telescoping elements 944. The head 942 preferably has a flat top that is substantially parallel to the top surface 912 of the base 910 and the top surface of the platform 924.

The support portion 960 includes the top plate 962 and a number of arms 964 that support the top plate 962 during use. The arms 964 are integrally connected with the top plate 962 at a reduced joint 968. The top plate 962 and arms 964 are flat and the arms 964 extend outward from the center top plate 962. The center top plate 962 is substantially parallel with the top surface 912 of the base 910, the top surface of the platform 924, and the top surface of the head 942. The arms 964 bend about the joints 968 with respect to the top plate 962. The arms 964 are elongated members that have a proximal end connected to the top plate 962 and a distal end with a thickened rounded tip 965. Optionally, transverse elongated slots 966 can be positioned to extend across the elongated arms 964 toward the distal ends of the arms 964.

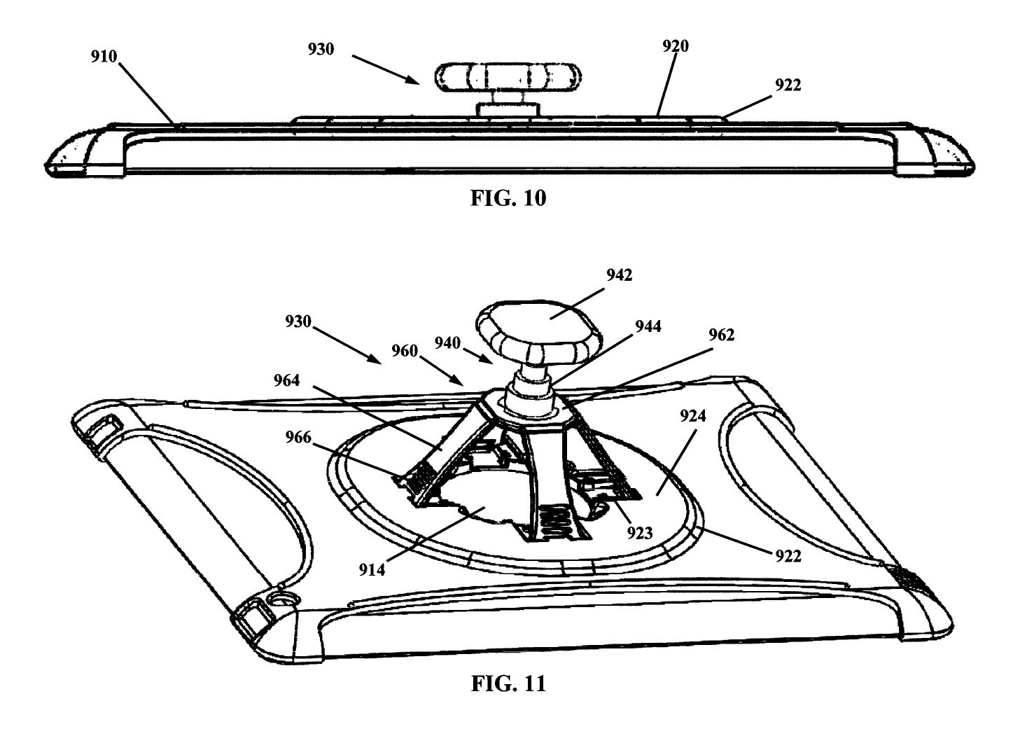

As best shown in FIGS. 12-13, the distal ends of the arms 964 are positioned within the channel 926 located between the bottom underside of the platform 924 and the top surface 912 of the base 910. The channel 926 slidably receives the respective arm 964 so that the arm 964 can be fully received in the channel 926 in a storage position (FIG. 9). In the storage position (FIGS. 9-10), the arms 964 lay flat and are substantially coplanar and recessed with respect to the top plate 962. In the extended or operating position (FIGS. 11-13), the arms 964 are fully extended and at least partly (or fully, except for the distal tip 965) withdrawn from the channel 926. A stop 929 is provided at the proximal end of the channel 926 and substantially aligned with the tab 928. The stop 929 cooperates with the tab 928 and/or platform 924 to prevent the thickened rounded tip 965 from escaping the channel 926. Thus, the distance between the stop 929 and the tab 928 or platform 924 is smaller than the thickness of the thickened rounded tip 965 of the arms 964, but larger than the thickness of the arms 964 themselves so that the arms 964 can be received in the channels 926. The distal tip 965 of the arm 964 is rounded so that it easily slides along the bottom of the channel 926 to move smoothly between the operating position and the storage position.

Cutouts 923 are formed in the platform 924 about the central opening 914. The cutouts are substantially rectangular in shape and have a tab 928 that projects inwardly from the inward-facing edge (i.e., the edge facing the central opening 914) of the cutout 923 toward the central opening 914. The tab 928 is smaller than the width of the inward-facing edge of the cutout 923. The cutouts 923 align with and receive the distal ends of the arms 964 of the support portion 960. Each of the locking tabs 928 align with and matingly engages one of the respective locking slots 966 in the arms 964. The tabs 928 and slots 966 cooperate to prevent the arms 964 from inadvertently sliding inward and into the channels 926 while in the operating position, to provide a grip that is adjustable to the size of the user's hands. The user can engage the tabs 928 with a desired one of the slots 966 to set a desired extension of the grip 930 in the operating position. Thus, a person with a small hand might use the topmost slot 966 so that the arms 964 are partially contained within the channels 926 and are shortened above the platform 924. And, a person with a larger hand might use the bottommost slot 966 so that the arms 964 are fully extended.

In addition, a shelf 925 is formed in the cutout 923. The shelf 925 has a flat top surface that is parallel to the top surface of the platform 924. The shelves 925 of each cutout 923 form a channel therebetween that is sized to receive the arms 964 in the storage position. The channels enable the arms 964 to be recessed with respect to the top surface 912 of the base 910 in the storage position. A small tab 927 projects inward from the shelves 925 to provide slight resistance against the arms 964 inadvertently coming free of the channel, thereby maintaining the arms 964 in the storage position.

In operation, the grip mechanism 932 can be moved between a compressed storage position (FIGS. 9-10) and an expanded operating position (FIGS. 11-13). In the storage position, the arms 964 are flat and substantially coplanar with the top plate 962. The head 942 is pushed inward with the rod 943 and telescoping members 944 fully receded into one another. The head 942 may extend above the top surface 912 of the base 910 by about one inch, but that can be reduced further, for instance by having the handle portion 940 recede into the central opening 914.

The device is configured to remain in the operating position until operated on by the user. To enter the storage position from the operating position, it may be necessary (if the slots 966 and the locking tabs 928 are provided) to first pull outward on the handle head 942 slightly, so that the tabs 928 disengage the slots 966. The user then pushes inward on the top of the head 942. This forces the telescoping elements 944 to collapse inside one another and the T-shaped adapter 943 to recede into the telescoping elements 944. A small projection can be positioned on the outside of the bottommost telescoping element 944. The projection adds slight resistance to closing to prevent the handle portion 940 from inadvertently collapsing from being bumped or the like. The inward force applied by the user overcomes that resistance. An annular lip (not shown) extends slightly outward from a top portion of the bottommost telescoping member 944 to prevent the telescoping members 944 from passing too far through the top plate 942.

The inward force on the head 942 also pushes inward (down in the embodiments shown) on the top plate 962 of the support portion 960. That in turn causes the arms 964 to slide outwardly with respect to the central opening 914 within the respective channels 926. As the arms 964 move outward, they bend about the joints 968. As the arms 964 continue to slide outwardly, the force applied by the user pushes the arms 964 to fall within the respective channels between the shelves 925 and beyond the tabs 927.

In the operating position (FIGS. 11-13), the telescoping elements 944 and rod 943 are fully extended. The arms 964 are at an angle, preferably about 45° with respect to each of the top plate 962 and the top surface 912 of the base 910. In accordance with the preferred embodiment, the head 942 is approximately 2.5 inches above the top surface 912 of the base 910.

The device is configured to remain in the storage position until operated on by the user. To enter the operating position (FIGS. 11-13) from the storage position (FIGS. 9-10), the user grabs under the head of the grip mechanism 930. The user can also (or instead) optionally reach into the central opening 914, such as via the beveled access cutout 921, and grab under the top plate 962 to lift the arms 964. By pulling upward on the head 942, the telescoping elements 944 are extended outward until the lips 946, 948 of adjoining telescoping elements 944 engage one another and the tab (if provided) on the outside of the bottommost element 944 is engaged.

Once all of the lips 946, 948 are fully engaged, such that all of the telescoping members 944 are fully extended, the bottommost telescoping element 944 pulls upward on the top plate 962. That, in turn, pulls the arms 964 upward and out of the channels 926, past the tabs 927. The arms 964 may flex during this motion, and the arms 964 bend at the joint 968 as the top plate 962 moves further outward. The arms 964 can be positioned in one of the slots 966 to set a desired length. Otherwise, the arms 964 will continue to slide all the way along the channel 926 until the thickened rounded tip 965 comes into contact with the stop 929. At this point, the arms 964 are full extended.

As the grip mechanism 930 is moved between the operating position and the storage position, the flat top surface of the head 942 remains substantially parallel to the top surface 912 of the base 910, the top surface of the platform 924, and the plate 962. The head 942 is rectangular or square shaped, so that the holder is balanced if placed on a flat surface.

As mentioned, the base 910 and raised section 920 are formed of hardened rigid plastic or the like. The platform 924 is preferably raised about one-quarter inch from the top surface 912 of the base 910. The handle portion 940 (including the head 942 and the telescoping portion 944) is formed of a rigid plastic. A softened rubber coating or exterior is provided about the head 942 for user comfort and to prevent slippage while being held or moved between the operating and storage positions. The support portion (including the arms 964 and the top plate 962) are preferably formed of a more flexible plastic. The arms 964 are sufficiently thick to provide sturdy support to the device, but also are sufficiently flexible to flex slightly and enable movement between the operating and storage positions. The arms 964 are also sufficiently flexible to bend at the joints 968 (which have a slightly reduced amount of material) as the support portion 960 moves between the operating and storage positions.

The grip mechanism 930 is preferably configured to have a dome shape. It is further preferable that the grip 930 be relatively stiff and with a fair amount of friction fit. Thus, it requires the user to exert more than a slight force to move the grip 930 between the operating position and the storage position. This is done so that the grip 930 does not inadvertently move between the two positions. And, so that the grip mechanism 930 stays fully open in the operational position during use without collapsing even slightly. In this manner, the user can grasp the grip mechanism 930 in any variety of ways without fear that it will collapse. For instance, the user can place his fingers in the opened spaces between the extended arms 964, or cup the arms 964 in his palm and fingers, with the telescoping elements and/or rod 943 positioned between two fingers.

It should be noted that while a handle portion 940 is utilized in the embodiments shown in FIGS. 9-13, the handle portion 940 need not be provided. Rather, the user can push down on the top of the top plate 962 to collapse the device into the storage position. And, the user can pull up on the underside of the top plate 962 to raise the device into the operating position.

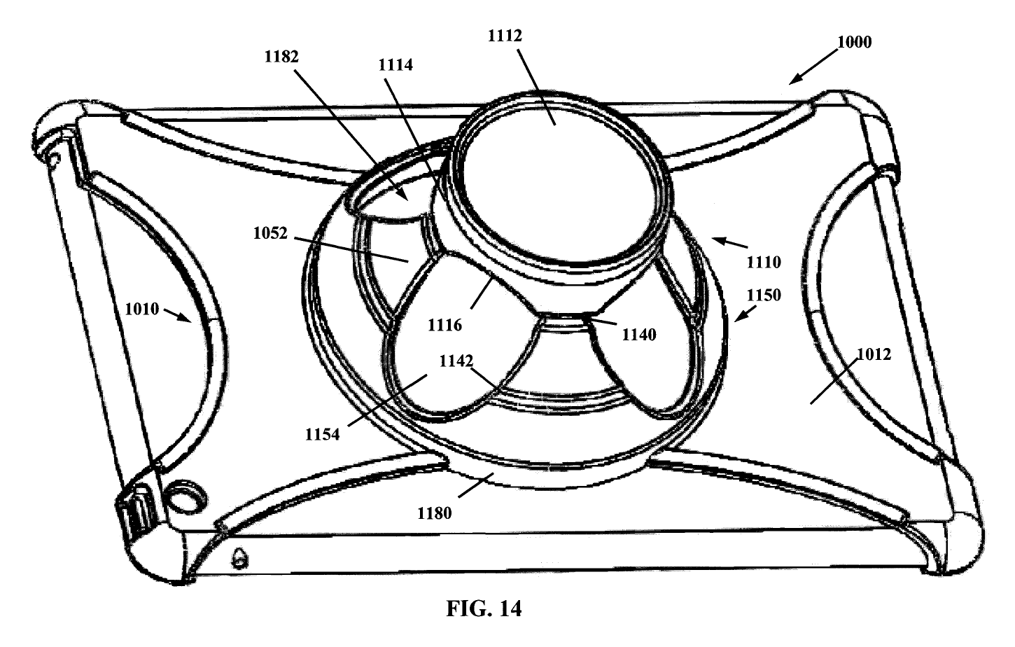

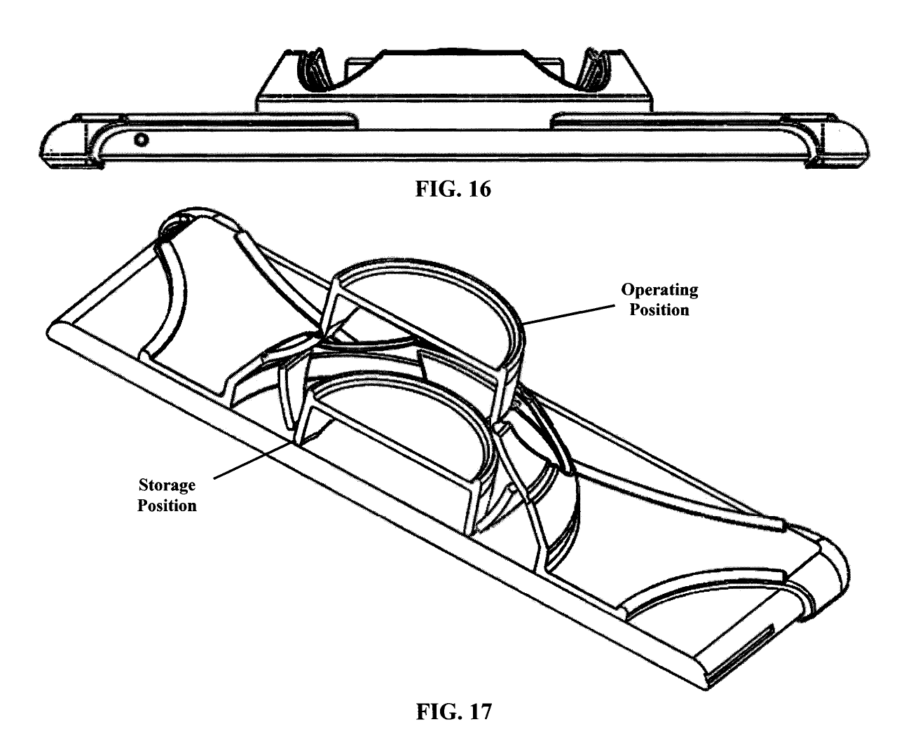

Turning to FIGS. 14-17, another illustrative embodiment of the portable holder 1000 is shown in accordance with the invention. This embodiment is particularly well suited for smaller hand-held portable electronic devices such as a smart phone, whereas the embodiment of FIGS. 9-13 is especially suited for slightly larger hand-held portable electronic devices such as a tablet.

The holder 1000 has a base 1010 and a grip mechanism 1100. The base 1010 is similar to the earlier embodiments and operates to engage the electronic device. The grip mechanism 1100 has a head portion 1110, a base portion 1180, and an intermediary support portion 1150 positioned between the head portion 1110 and the base portion 1180. The grip 1100 including the head portion 1110 and support portion 1150 are circular in shape and generally form a flattened dome shape as in the prior embodiments.

The head portion 1110 includes a flat top plate 1112 and neck 1114 that is substantially orthogonal to and extends downward (with respect to the embodiment shown) from the top plate 1112. The bottom or distal edge 1116 of the neck 1114 is curved.

The support portion 1150 is formed by arms 1152 that extend downward and outward from the head portion 1110. The arms 1152 are narrow at the top and taper outward to be wider at the bottom where they connect to the base portion 1180. Openings 1154 are formed in the support portion 1150 that define the arms 1152. The openings 1154 are circular or oblong in shape and defined by the curved bottom edge 1116 of the neck, and the sides of the arms 1152. The openings 1154 are large enough to receive a user's finger(s) so that the user can pull up on the head portion 1110 by grasping one or more of the curved distal edges 1116.

The base portion 1180 is a flat circular member and is substantially orthogonal to the top surface 1012 of the base 1010, so that the base portion 1180 can be easily coupled with (such as by adhesives or fasteners) the base 1010. The base portion 1180 and arms 1152 support the head portion 1110 during use. A central opening 1182 is provided in the base 1010. It should be noted, however, that the base 1010 and base portion 1180 can be continuous and not have a central opening, and that the base portion 1180 can be coupled (such as by adhesives or fasteners) with the top surface 1012 of the base 1010.

Each arm 1152 is integrally coupled with the neck 1114 at a first fold or joint 1140. The first joint 1140 has a reduced thickness compared to the arms 1152 and/or neck 1114. The first joint allows the arms 1152 to be pivotally connected with the neck 1114 so that the arms 1152 can move with respect to the head portion 1110 as the grip 1100 moves between a storage position and an operating position. Each arm 1152 also has a second fold or joint 1142 formed about mid-way on the arm 1152 so that each arm 1152 can be folded approximately in half about the second joints 1142 as the grip 1100 moves between the storage position and the operating position. The second joints 1142 have a reduced thickness compared to the rest of the arms 1152, so that the arms 1152 can be easily folded.

Referring to FIGS. 14 and 17, the holder 1000 is shown in the operating position. Here, the arms 1152 are fully extended so that the top plate 1112 is furthest away from the base 1010. The second joint 1142 is not folded, so that the arms 1152 are substantially straight (though curved to form the dome shape). The first joint 1140 is configured so that the arms 1152 are at an obtuse angle with respect to the head portion 1110, preferably about 120°.

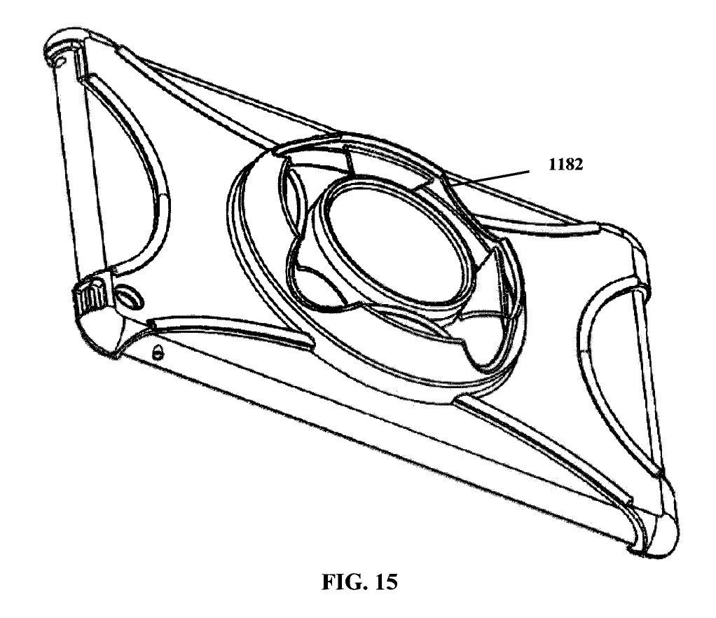

The device is configured to remain in the operating position until operated on by the user. To move from the operating position (FIG. 14) to the storage position (FIGS. 15-17), the user presses inward on the top of the top plate 1112. That forces the top plate 1112 inward toward the computer. The joints 1140 then start to fold so that the top plate 1112 continues to move inward until the grip 1100 reaches the storage position.

In the storage position, the first joint 1140 forms an acute angle with respect to the head portion 1110, preferably about 30°. And, the second joint 1142 is folded so that the arms 1152 are substantially folded in half. Accordingly, the top plate 1112 is at a closer position to the electronic device. The device is configured so that it remains in the storage position until operated on by the user. To move from the storage position to the operating position, the user reaches through the base opening portion 1182 in the base 1180 (FIG. 15), grasps under the distal edge 1116 of the neck 1114 and pulls outward (upward in the embodiments). Alternatively, the user can simply grasp the sides of the top plate 1112 and neck 1114 and pull outward. The joints 1140, 1142 then pivot to allow the arms 1152 and top plate 1112 to extend outward away from the computer device.

The grip 1100 is formed as a single integrally molded piece. The base 1010 is a rigid plastic, whereas the grip 1100 is a more flexible but sturdy plastic that allows folding about the joints 1140, 1142. The head portion 1110 and/or support portion 1150 can be coated with a rubber so it is easy to grab and more comfortable to hold. Further to one preferred embodiment of the invention, the height in the storage position is approximately 0.875 inches, and in the operating position is approximately 2.0 inches. The top plate 1112 has a diameter of about 2.0 inches, and the base portion 1180 has a diameter of about 3.75 inches. The device is configured to hold an electronic device that is 5.312 inches wide, 7.750 inches long and about 0.350 inches thick.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A portable computer holder comprising:
a holder base with a front face and a rear face opposite the front face, the holder base being configured to hold a portable computing device at its front face by engaging distal edges of the portable computing device; and,
a grip extending from the rear face of the holder base, the dome-shaped grip having an operating position and a storage position.

2. The portable computer holder of claim 1, wherein said shaped grip includes a top plate and a plurality of arms extending outward from said top plate.

3. The portable computer holder of claim 2, further comprising a raised platform mounted to the rear face of said holder base and coupled with said grip.

4. The portable computer holder of claim 4, further comprising a plurality of channels formed between the rear face of said holder base and said raised platform, wherein each of said arms is slidably received in a respective one of said plurality of channels.

5. The portable computer holder of claim 5, wherein said arms are received in said plurality of channels in the storage position and retracted from said plurality of channels in the operating position.

6. The portable computer holder of claim 5, wherein the grip further comprises a head and a telescoping body extended substantially orthogonal to said head, said telescoping body coupled with the top plate.

7. The portable computer holder of claim 2, wherein said arms have a first joint with reduced thickness and whereby each of said arms are folded about said first joint in the storage position.

8. The portable computer holder of claim 7, wherein said arms are coupled with the top plate about a second joint with reduced thickness and whereby said arms pivot with respect to the top plate about the second joint.

9. The portable computer holder of claim 1, wherein said grip is extended in the operating position and fully retracted in said storage position.

10. The portable computer holder of claim 1, wherein the holder base is formed of a rigid material.

11. The portable computer holder of claim 10, wherein the grip has a top plate and a plurality of arms, and the plurality of arms are formed from a flexible but stiff material.

12. The portable computer holder of claim 1, wherein the grip can be moved between the operating position and the storage position.
